(19) United States
(12) Patent Application Publication
(10) Pub. No.: US 2024/0181498 A1
(43) Pub. Date: Jun. 6, 2024

(54) METHOD OF DETECTING WEAR AND TEAR IN A ROTATING OBJECT

(71) Applicant: TRIAD National Security, LLC., Los Alamos, NM (US)

(72) Inventors: Troy Allen Semelsberger, Los Alamos, NM (US); Cristian Pantea, Los Alamos, NM (US); John James Greenhall, Los Alamos, NM (US)

(21) Appl. No.: 18/571,647

(22) PCT Filed: Jun. 24, 2022
(86) PCT No.: PCT/US2022/034892

§ 371 Date: Dec. 18, 2023

Related U.S. Application Data
(60) Provisional application No. 63/214,663, filed on Jun. 24, 2021.

(51) Int. Cl. B06B 1/06; G01N 29/44

(52) U.S. Cl. CPC B06B 1/0655; G01N 29/4436; G01N 29/4454

(57) ABSTRACT

A method includes acoustically exciting a rotating component over a range of frequencies. The method further includes measuring the resulting frequency response of the rotating component in response to the acoustic excitation. The method also includes processing the frequency response to determine whether a frequency response has shifted in comparison a prior frequency response. The method includes determining an amount of wear and tear of the rotating component based on the determined shift in the frequency response.

### RELATED APPLICATIONS

This is a US National Stage Application that claims the benefit and priority to the PCT Application number PCT/US22/34892, which was filed on Jun. 24, 2022 and claims the benefit and priority to the Provisional Application No. 63/214,663, which was filed on Jun. 24, 2021, and both of which are incorporated herein by reference in their entirety.

### FEDERALLY SPONSORED RESEARCH OR DEVELOPMENT

The United States government has rights in this invention pursuant to Contract Number 89233218CNA000001 between the U.S. Department of Energy and Triad National Security, LLC for operation of Los Alamos National Laboratory. The government has certain rights in the invention.

### BACKGROUND

Many industries use rotating components for various applications. For example, brake pads, rotating shaft, e.g., in a hard drive motor, in an electric motor, etc., wind turbine blades, plug-screw feeder, etc., all use rotating components. In one nonlimiting example, a plug-screw (e.g., auger) feeder pressurizes feedstock and controls the feed rate for processing biomass that is used to generate liquid fuel such as ethanol and butanol, alcohol fuel, landfill gas, solid waste, and wood and agricultural products. Regardless of the application, rotating components are not only subject to routine wear and tear but may get damaged sooner than expected, e.g., a debris getting stuck in the plug-screw feeder may damage the plug-screw feeder, dust or particles being introduced to the rotating shaft of the motor in a hard drive may damage the rotating shaft of the motor, etc. Property damage and/or bodily harm may result from the rotating component being damaged, regardless of whether it is due to regular wear and tear or not, if the damage goes unnoticed and unaddressed.

Unfortunately, inspecting a rotating component often requires the use of the device to be stopped, the rotating component to be remove in order to be manually inspected, thereby resulting in downtime. This downtime has significant importance especially in industrial settings. Replacing a rotating component without inspection on the other hand is not only wasteful because the rotating object may not be in need of replacing but it also results in unnecessary downtime.

### SUMMARY

Accordingly, a need has arisen to monitor wear and tear and generally damage a rotating component, e.g., screw, shaft, auger, etc. In some embodiments, the monitoring is achieved by acoustically exciting the rotating component (regardless of whether the rotating object is in operation or not) and by measuring a frequency response of the rotating component. Wear and tear of a rotating component results in the frequency response that is different, e.g., shifted, from a rotating component that is undamaged. Accordingly, a comparison of a frequency response of a rotating component to its own frequency response (or to a model's frequency response) without wear and tear reveals whether a shift in frequency response has occurred when the rotating object is excited acoustically. It is determined that the rotating object is damaged if the frequency response has shifted. The amount of damage or placement of the damage (also referred to as mode), e.g., tip of the rotating object, middle of the rotating object, etc., may be determined based on the frequency response and the amount of frequency shift.

In some embodiments, a method includes acoustically exciting a rotating component during rotation. The method further includes measuring a frequency response of the rotating component in response to the acoustic excitation. The method also includes processing the frequency response to determine whether a frequency response has shifted in comparison to a baseline frequency response. The method includes determining an amount of wear and tear of the rotating component based on the determined shift in the frequency response.

These and other features and aspects of the concepts described herein may be better understood with reference to the following drawings, description, and appended claims.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts a nonlimiting example of an auger used in plug-screw feeder.

FIG. 2A depicts a system setup to acoustically excite a rotating component and to measure its frequency response to determine whether the rotating component is damaged in accordance with some embodiments.

FIG. 2B depicts a system setup to acoustically excite an auger and to measure its frequency response to determine whether the rotating component is damaged in accordance with some embodiments.

FIG. 3A depicts a frequency response in experimental and simulated setting in accordance with some embodiments.

FIG. 3B depicts a nonlimiting example of a comparison of a frequency response for a damaged versus undamaged rotating component in accordance with some embodiments.

FIGS. 4A and 4B depict nonlimiting examples of a frequency response associated with different modes of rotating component in accordance with some embodiments.

FIG. 4C depicts a nonlimiting example of a frequency response associated with different modes of a rotating component with various damage severity in accordance with some embodiments.

FIG. 4D depicts a nonlimiting example of a frequency response associated with different modes of a rotating component with various damage severity in air operation and in actual operation in accordance with some embodiments.

FIG. 5 depicts a nonlimiting example of a frequency response associated with rotating component damages (e.g., mass loss) in actual operation in comparison to in air operation in accordance with the some embodiments.

FIG. 6 depicts a nonlimiting example of a frequency response associated with various modes of a rotating component with different damage severity in accordance with some embodiments.

FIG. 7 depicts a nonlimiting example of an undamaged screw and a damaged screw with different modes and severity of damages in accordance with some embodiments.

FIG. 8 shows a nonlimiting example of a flow diagram associated with determining damages to a rotating component in accordance with some embodiments.

FIG. 9 shows a block diagram depicting an example of computer system suitable for measuring/processing frequency response of a rotating component in accordance with some embodiments.

### DETAILED DESCRIPTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Before various embodiments are described in greater detail, it should be understood that the embodiments are not limiting, as elements in such embodiments may vary. It should likewise be understood that a particular embodiment described and/or illustrated herein has elements which may be readily separated from the particular embodiment and optionally combined with any of several other embodiments or substituted for elements in any of several other embodiments described herein. It should also be understood that the terminology used herein is for the purpose of describing the certain concepts, and the terminology is not intended to be limiting. Unless defined otherwise, all technical and scientific terms used herein have the same meaning as commonly understood in the art to which the embodiments pertain.

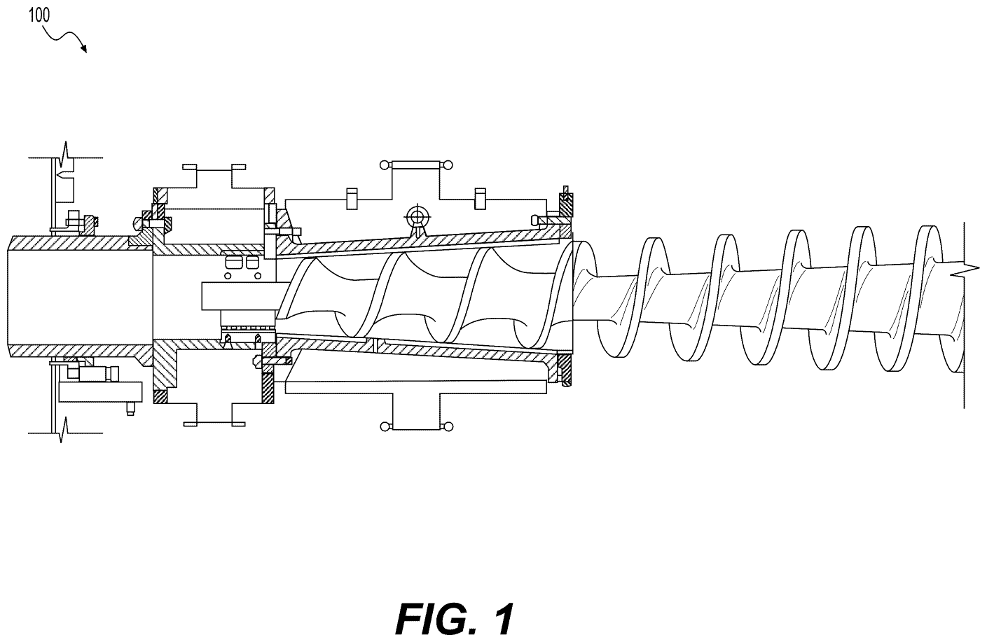

An auger or a rotating component may be used for various purposes in a system. For example, in FIG. 1, a plug-screw (e.g., auger) feeder pressurizes feedstock and controls the feed rate for processing biomass that is used to generate liquid fuel such as ethanol and butanol, alcohol fuel, landfill gas, solid waste, and wood and agricultural products. In this example, the auger along with high pressure solid plug is used to receive a low-pressure biomass slurry and pushes it out at a high pressure. As described above, there is a need to monitor wear and tear and general damage of a rotating component.

In some embodiments, the system may include an acoustic transmitter, e.g., acoustic transducer, to generate an acoustic signal. It is appreciated that use of an acoustic transmitter and its description throughout the application is provided for illustration purposes and should not be construed to limit the scope of the embodiments. For example, in some embodiments, electrodynamic shaker may be used. The acoustic signal causes a rotating component to vibrate, regardless of whether the rotating component is in operation, e.g., actual operation, or whether it is operating in air, as a nonlimiting example. It is appreciated that a sensor/detector may be used to detect the vibrations of the rotating component. As such, the frequency response of the rotating component is determined. The frequency response of the rotating component may be compared to the same rotating component when installed (i.e., no wear and tear but having the same geometrical profile) or to a model rotating component. It is appreciated that the frequency response when installed or from a model without wear and tear may be referred to as the baseline frequency response. It is further appreciated that the baseline frequency response may also refer to a frequency response of the auger after a period of time after the auger has been installed and has been operating. In one example, the baseline frequency response may be the frequency response after a certain period of time after which the auger has experienced some wear and tear. Wear and tear causes a shift in the frequency response. It is appreciated that the amount of shift in frequency response may be correlated to the amount of damage (i.e., severity) to the rotating component. In other words, the frequency of the frequency response is tracked as opposed to the amplitude of the frequency response in order to determine the amount of damage to the rotating component.

Accordingly, the amount of damage to a rotating component can be determined without a need to remove the rotating component for inspection, thereby eliminating downtime associated with the removal and inspection of the rotating component. Moreover, the amount of damage to the rotating component can be made regardless of whether the rotating component is in operation. This results in significant improvement in industrial settings because not only the rotating component does not have to be removed for inspection, resulting in downtime, but it can be in fact inspected for any damage to the rotating component as it operates.

A different acoustic excitation (i.e., different profile and frequencies) may excite different aspects/areas (i.e., mode) of the rotating component, which may result in a different frequency response, thereby enabling damages to different areas to be tracked. Each of the resonant modes are affected differently as different areas of the rotating component are worn. Thus, by tracking multiple resonant modes, one can identify the region that was subjected to the wear. Mode may refer to geometrical profile of the rotating component, e.g., flexural, longitudinal, tip of the rotating component, middle of the rotating component, base of the rotating component, the lead which is the axial distance that the screw travels in one complete revolution of the shaft, the pitch which may be the axial distance between the crests of adjacent threads, the profile of the threads, the thread angle, the type of threads (e.g., V thread, square thread, American National, Whitworth Standard, acme thread, buttress thread, knuckle thread, metric thread, etc.), etc. The peaks in the frequency response can be used to determine the location of the damage, the amount of damage, etc. In other words, different acoustic excitations (i.e., different profile) result in different frequency response peaks that can be correlated to a particular aspect (e.g., damage to the tip, damage to the middle, damage to the base, damage to the pitch of the thread, damage to the thread angle, etc.) of the rotating component and whether it is damaged and the amount of damage.

It is appreciated that throughout the application the embodiments are described with respect to the rotating component being an auger for illustration purposes and should not be construed as limiting the scope of embodiments. For example, the rotating object can be a screw, a shaft, etc.

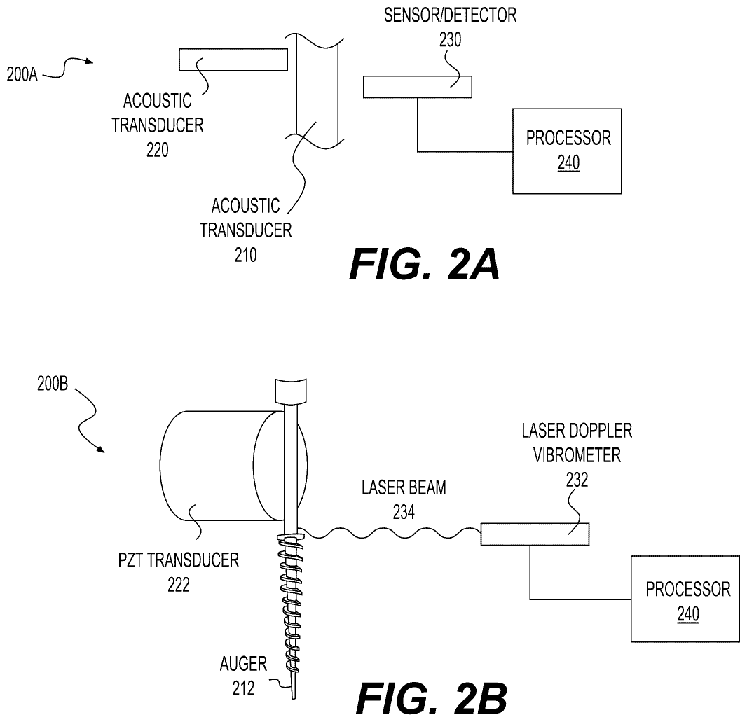

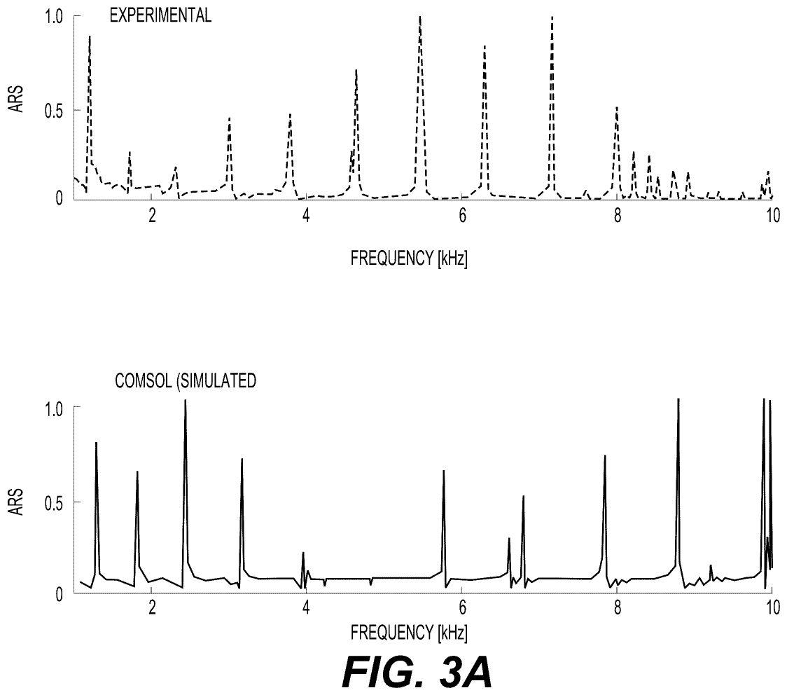

Referring now to FIG. 2A, a system setup 200A to acoustically excite a rotating component and to measure its frequency response to determine whether the rotating component is damaged in accordance with some embodiments is depicted. System 200A includes a rotating component 210, an acoustic transmitter 220, a sensor/detector 230, and a processor 240.

The rotating component 210 is configured to rotate. The acoustic transmitter 220 is configured to generate an acoustic signal. The acoustic transmitter 220 is coupled to the rotating component 210 and when the acoustic signal is generated, it causes the rotating component 210 to vibrate (regardless of whether in operation or not) and generate a frequency response. The acoustic signal may be designed to have a desired acoustic signal profile with a particular frequency or range of frequencies (i.e., bandwidth). It is appreciated that different acoustic signals may generate a different frequency response by the rotating component 210, as described above. The range of frequencies that are excited are selected to ensure that they encompass sufficient resonant modes of the rotating object. The vibration of the rotating component 210 responsive to the acoustic signal, i.e., frequency response, is detected by the sensor/detector 230. The sensor/detector 230 may be any pressure or vibration sensor, such as an accelerometer, a micro-electromechanical system (MEMS) vibration sensor, electromagnetic acoustic transmitter (EMAT), piezoelectric transducer, laser-Doppler vibrometer (LDV), optical microphone, electrodynamic receiver manifold air (MAT) sensor, CMUT (capacitive micromachined ultrasonic transducers), PMUT (Piezoelectric Micromachined Ultrasonic Transducer), etc. The frequency response of the rotating component 210 as detected by the sensor/detector 230 may be processed by the processor 240, e.g., a central processing unit (CPU), etc., to determine the amount of damage and/or the location of the damage.

In general, damage to the rotating component 210 results in a shift in frequency response when the rotating component 210 is acoustically excited in comparison to the frequency response when the rotating component 210 is undamaged. In some nonlimiting examples, the frequency response of the rotating component 210 is obtained when the rotating component 210 is first installed in order to develop a baseline for the frequency response for later comparison to a frequency response in order to determine whether the rotating component 210 has been damaged. In another nonlimiting example, a frequency response of a different undamaged rotating component may be used as a baseline for comparison to a frequency response of the rotating component in order to determine whether the rotating component 210 has been damaged. According to some embodiments, the processor 240 may determine the amount of damage and if the amount of damage exceeds a particular threshold, it may output a signal to indicate that the rotating object 210 is damaged and needs to be replaced. For example, the processor 240 may determine that the rotating component 210 needs to be repaired or replaced if its frequency response has shifted more than a threshold amount. The output signal may be transmitted via any mean, e.g., Bluetooth, IoT (Internet of Things), etc. In some embodiments, the output signal indicating that the rotating object 210 should be replaced may be in a form of an email, LED light, etc. As such, the system operator may be notified of catastrophic failure in the rotating component and can attend to replacing or repairing the rotating component, as needed, in a timely fashion.

It is appreciated that different rotating objects may have a different frequency response when acoustically excited depending on the profile of the rotating object. For example, a screw with a first pitch, a first angle, and a first type may not only have a different frequency response to the same acoustic signal but it may have a different amount of shift in frequency response when it is damaged in comparison to a screw with a second pitch, a second angle, and a second type. Similarly, a screw with a particular dimensions and shape may not only have a different frequency response to the same acoustic signal but it may have a different amount of shift in frequency response when it is damaged in comparison to a screw with a different shape and/or dimensions. As such, any references to particular amount of shift in frequency response and/or shape of the frequency response is for illustration purposes and should not be construed as limiting the scope of the embodiments.

FIG. 2B depicts a system 200B setup to acoustically excite an auger and to measure its frequency response to determine whether the rotating component is damaged in accordance with some embodiments. FIG. 2B is similar to that of FIG. 2A where the rotating component 210 is an auger 212, the acoustic transmitter 220 is a piezoelectric (PZT) transducer 222, and the sensor 230 being a laser-Doppler vibrometer (LDV) 232. System 200B operates substantially similar to system 200A. In this embodiment, the LDV 232 transmits a laser beam 234 to the auger 212 that is rotating. When the PZT transmitter 222 generates an acoustic signal, the LDV 232 detects vibration variations in the auger 212. It is appreciated that auger vibration may be detected either when the auger 212 is rotating or when the auger 212 is in a stationary state. As such, the frequency response of the auger 212 is determined by the processor 240, which further determined whether the auger 212 is damaged and the amount of damage. In other words, the processor 240 may determine whether the amount of damage exceeds a particular threshold, based on the frequency response of the auger 212, to classify the damage as catastrophic and to trigger a signal to notify the operator to either repair or replace the auger 212.

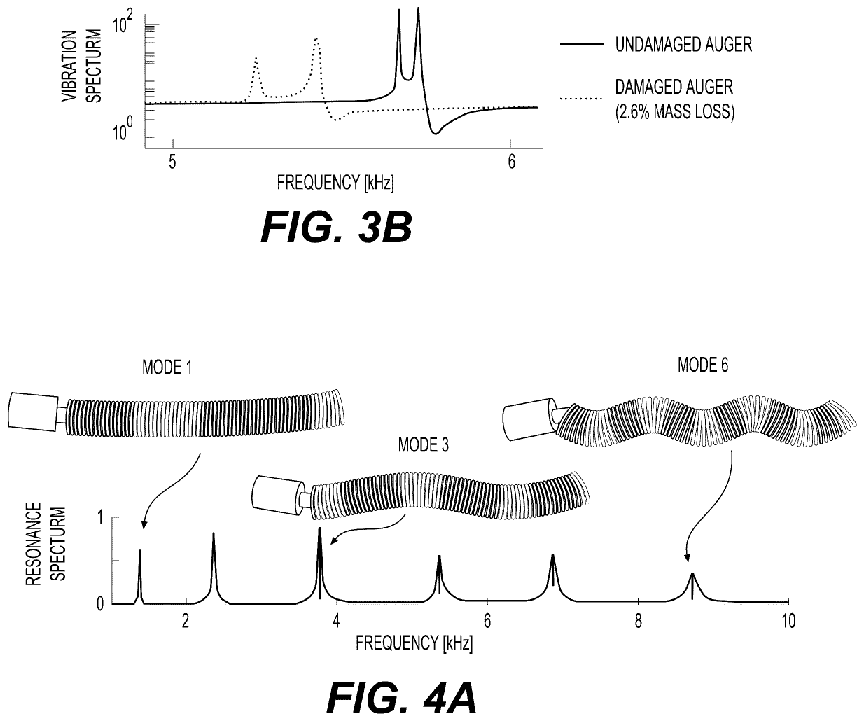

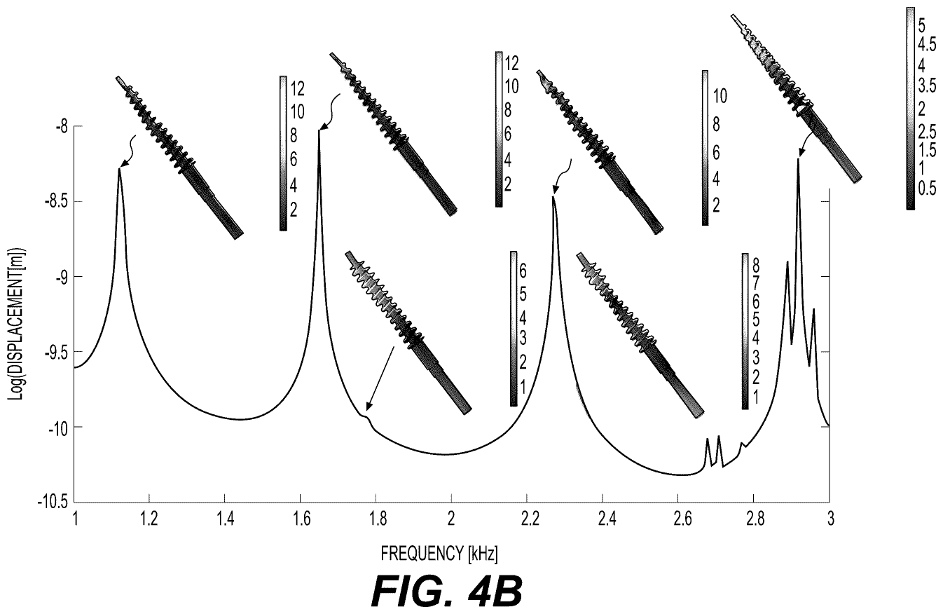

Referring now to FIG. 3A, a frequency response in experimental and simulated setting in accordance with some embodiments is depicted. Comparison of the experimental and simulated resonance spectra may determine the model error which may be based on geometric differences and experimental damping. Referring now to FIG. 3B, a nonlimiting example of a comparison of a frequency response for a damaged versus undamaged rotating component in accordance with some embodiments is depicted. In this nonlimiting example, two peaks are observed at approximately 5.75 kHz for an undamaged auger, whereas these peaks are shifted to approximately 5.25 kHz after the auger is damaged (2.6% of the mass is removed from the auger threads). In other words, the frequency response of a damaged rotating component shifts down, in this nonlimiting example. It is noteworthy that the amplitude of the frequency response peaks may be irrelevant in determining whether the rotating component is damaged, instead the shift in frequency indicates damage.

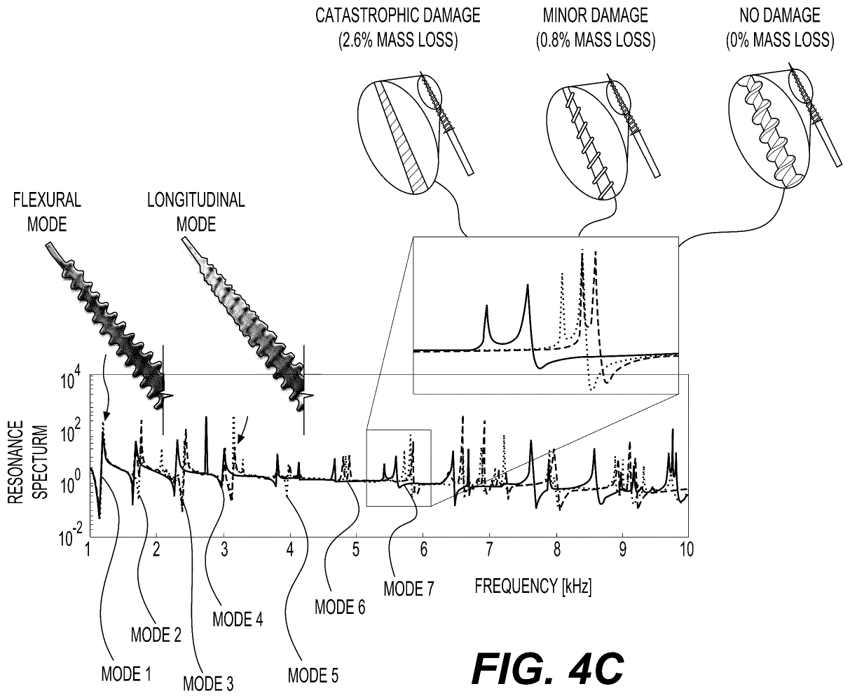

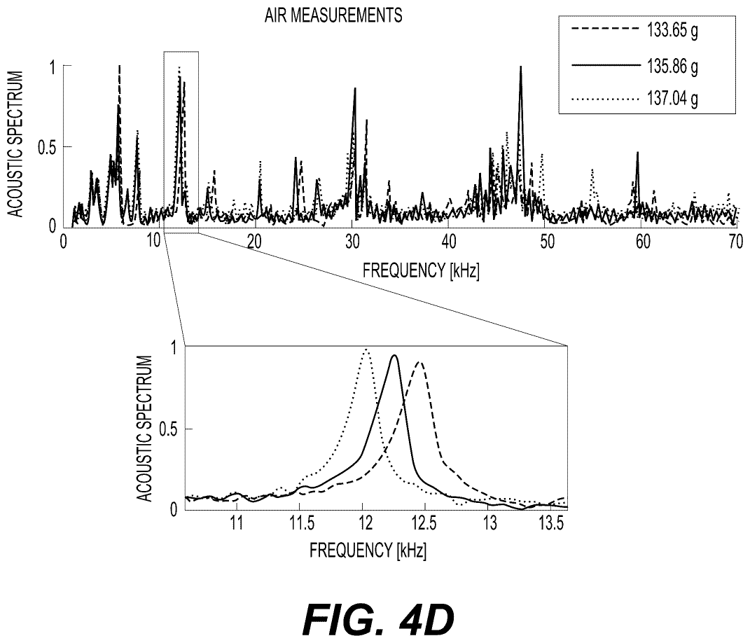

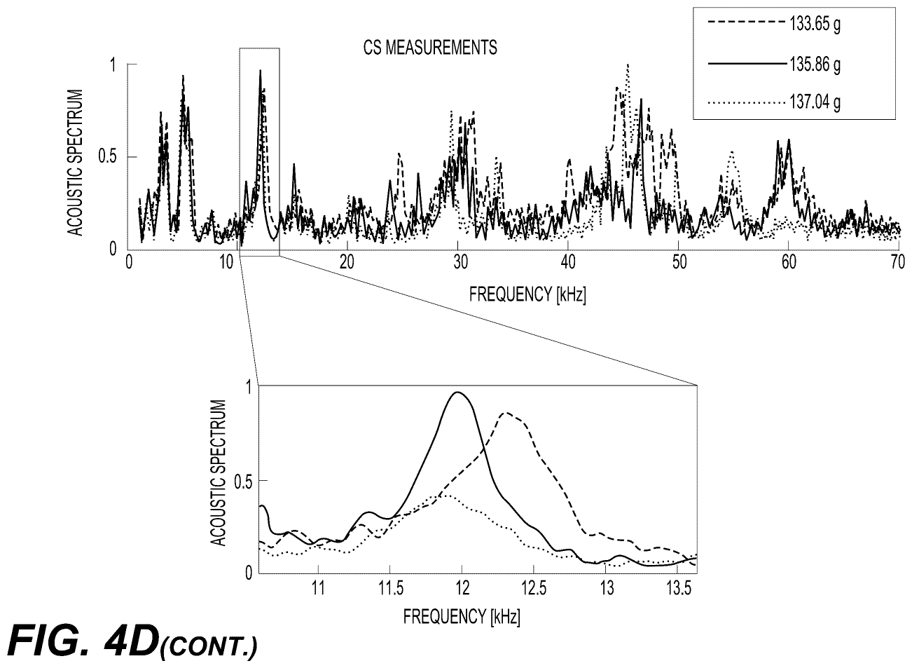

Referring now to FIG. 4A, a frequency response associated with different modes of a rotating component in accordance with some embodiments is shown. In this nonlimiting example, each peak of the frequency response when the rotating component is acoustically excited is associated with a mode. For example, mode 1 may be associated with a peak at frequency of almost 1 kHz, while mode 3 may be associated with a peak at frequency of 4 kHz, mode 6 may be associated with a peak at frequency of 9 kHz, etc., when the rotating component is undamaged. It is appreciated that over time and due to wear and tear, a frequency response of the rotating component changes and the frequency response may shift. For illustration purposes, a frequency response having a peak at 0.8 kHz may indicate a shift in frequency for mode 1 whereas a peak at 3.9 kHz may indicate a shift in frequency for mode 3, etc.

Referring now to FIG. 4B, another nonlimiting example of a frequency response associated with different modes of a rotating component in accordance with some embodiments is shown. In this example, the rotating component has frequency response peaks at different frequencies where each peak is associated with a particular mode of the rotating component.

It is appreciated that the damage may be quantified by measuring the frequency shift in each resonant mode. A polynomial fit for measuring the damage may be represented below:

\hat{δ}=Σₙg(fₙ), for all modes n

where δ is the amount of damage. The damage may be associated with the tip of a rotating component, e.g., the length of the rotating component to its original length, associated with the thread, e.g., the amount of thread damage to the entire threads, and associated with mass damage, e.g., mass loss, which are all represented for illustration below. It is appreciated that the equations below are shown for illustrative purposes and should not be construed as limiting the scope of the embodiments. For example, other metrics such as depth of the thread, width of the thread, etc., may be used to identify various types of damages, e.g., tip damage, thread damage, mass damage, etc.
Tip damage: δₜᵢₚ=Iₜᵢₚ/L
Thread damage: δₜₕᵣ=Iₜₕᵣ/L
Mass damage: δₘₐₛₛ=(m−m₀)/m₀.

Referring now to FIG. 4C, a nonlimiting example of a frequency response associated with different modes of a rotating component with various damage severity in accordance with some embodiments is shown. In this nonlimiting example, progressive levels of damages are applied to the rotating component and the resonance spectrum is measured. In this nonlimiting example, mode 7 that is within a 5-6 kHz bandwidth is examined. An inset image illustrates a shift to a lower frequency as damage to the rotating component becomes more significant, e.g., from 0% mass loss to 0.8% mass loss to 2.6% mass loss. For illustrative purposes a 2.6% mass loss may be a threshold representing catastrophic damage. As such, damage greater than or equal to 2.6% may trigger a notification signal to be issued, as discussed above. In some nonlimiting example, the threshold may be 2.3%. It is appreciated that damage to the rotating component may create or remove some coupled modes, thereby assisting in distinguishing damaged rotating components from undamaged ones.

It is appreciated that FIG. 4C is described with respect to a mass loss for illustrative purposes and should not limit the scope of the embodiments. For example, a similar frequency response may be used to quantify thread damage, tip damage, etc., as described by equations above.

Referring now to FIG. 4D, a nonlimiting example of a frequency response associated with different modes of a rotating component with various damage severity in air operation and in actual operation in accordance with some embodiments is shown. In this nonlimiting example, a frequency response of a rotating component, is measured, when suspended in air (left) at three different wear levels, as indicated by the auger mass. Similarly, a frequency response of the rotating component suspended in biomass (corn stover in this case), which damp vibrations more than air, can be measured when there is no mass loss and as it progressively loses mass due to wear and tear. As illustrated, operation in air has a higher signal to noise ratio with higher Q-factor in comparison to when the rotating component is subjected to CS damp vibrations. Moreover, there is a slight down-shift in resonant frequency when the rotating component is subjected to CS vibrations. However, the frequency response whether in air or CS, although shifted, can still be used to determine the amount of damage to the rotating component because it still causes a shift in frequency response.

It is appreciated that FIG. 4D is described with respect to a mass loss for illustrative purposes and should not limit the scope of the embodiments. For example, a similar frequency response may be generated based on thread damage, tip damage, etc., as described by equations above.

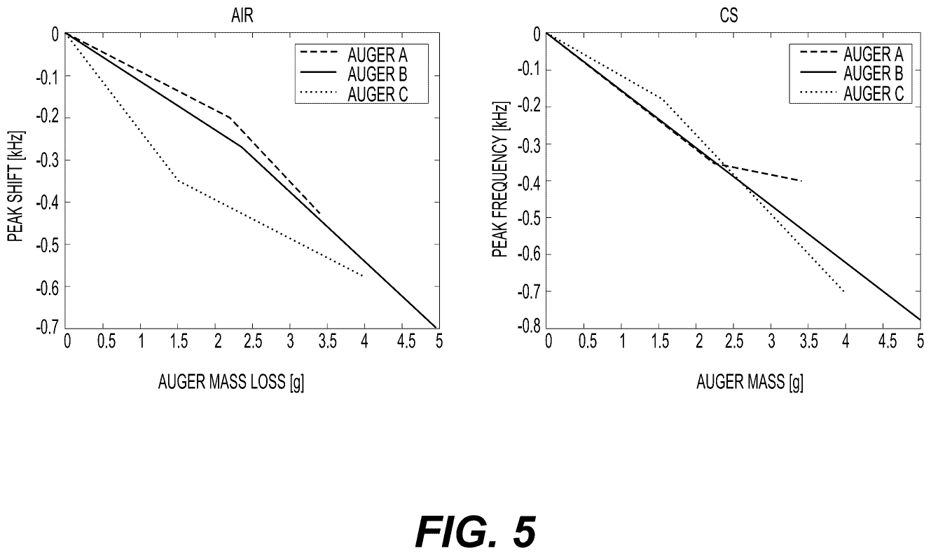

Referring now to FIG. 5, a nonlimiting example of a frequency response peak shift, compared to the peak location of the undamaged baseline augers. The peak shift is illustrated associated with rotating object damages (e.g., mass loss) in actual operation in biomass (right) in comparison to in air operation (left) in accordance with the some embodiments is depicted. As illustrated, three different augers (labeled Auger A-Auger C) with different wear profiles, suspended in air all show similar shifts in the frequency response peak as additional mass is lost through wear. Similarly, the same augers with different wear profiles show a shift in the frequency response peak as mass is lost, for the rotating component suspended in biomass. In other words, regardless of the shape/profile of the auger wear and regardless of the medium in which it rotates, the frequency response peak shifts by approximately the same amount (i.e. more mass loss results in more shift in downward direction of frequency response). In other words, tracking the frequency response peaks enables quantifying the mass-loss, i.e., the amount of damage to the rotating component.

It is appreciated that FIG. 5 is described with respect to a mass loss for illustrative purposes and should not limit the scope of the embodiments. For example, similar relationships to the peak shift can be established for thread damage, tip damage, etc.

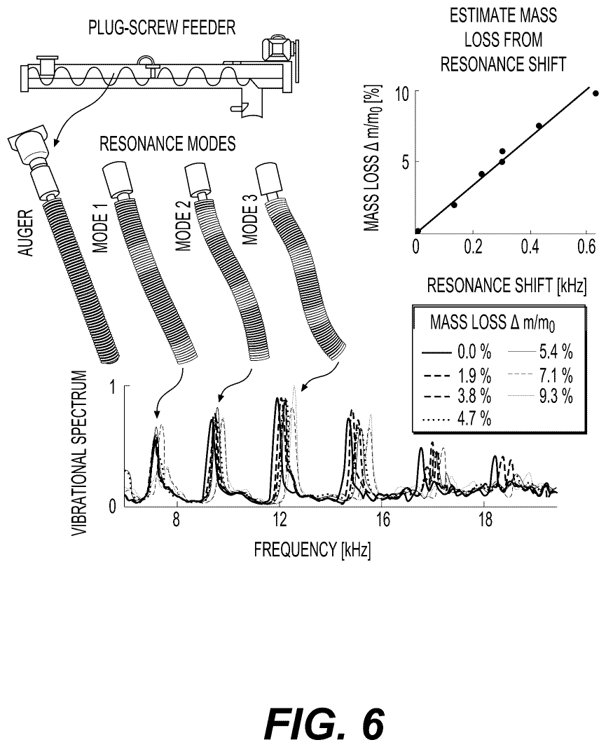

Referring now to FIG. 6, a nonlimiting example of a frequency response associated with various flexural resonance modes of a rotating object with different damage severity, quantified in terms of mass loss, in accordance with some embodiments is shown. In this example, the auger is subjected to wear over time. Exciting the auger with vibrations and then measuring the frequency response at different wear levels results in different frequency responses, i.e., changes in the peak frequencies and amplitudes, where each peak is associated with a different mode (i.e., a different vibration profile). In this example, the frequency of the third peak (near 12 kHz) is tracked as the auger loses mass to wear, e.g., from 0% to 9.3% mass loss. Comparing the peak position at each wear rate to the peak position of the baseline auger (0% mass loss) enables measuring the peak shift, which is proportional to the mass loss. In other words, the system as described above, enables tracking of shifting vibrational resonances to noninvasively measure auger wear. That is, during operation, augers are subjected to wear that shifts the frequencies of the auger natural vibration modes. Shifts in measured vibration spectrum are tracked to estimate an amount of damage associated with the auger. This enables noninvasive damage detection while the auger is in operation.

It is appreciated that FIG. 6 is described with respect to a mass loss for illustrative purposes and should not limit the scope of the embodiments. For example, a similar frequency response may be generated based on thread damage, tip damage, etc., as described by the equations above.

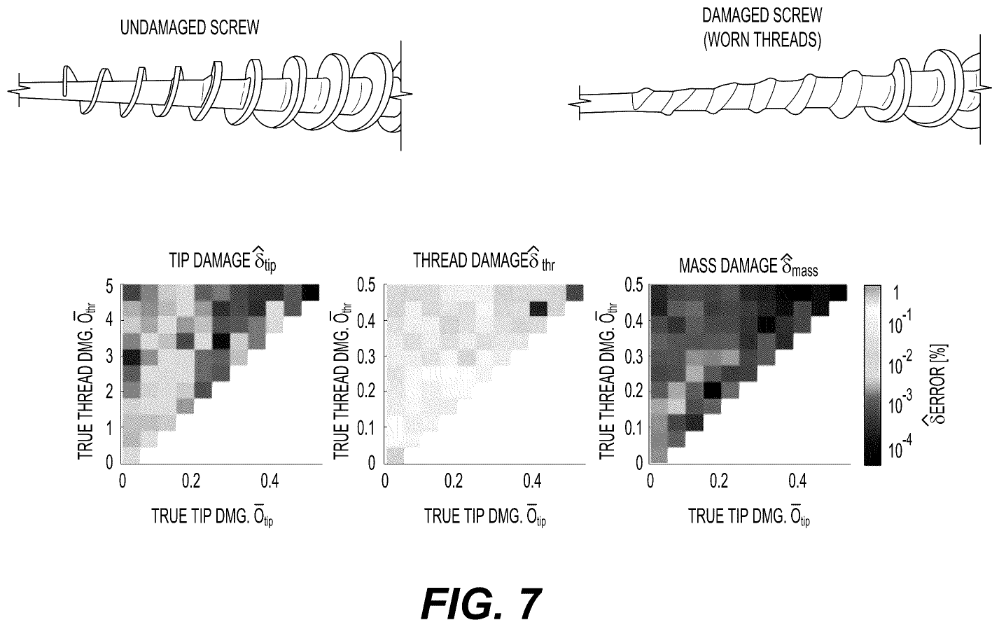

Referring now to FIG. 7, a nonlimiting example of an undamaged screw and a damaged screw with different modes and severity of damages in accordance with some embodiments is depicted. Moreover, a simulation as shown illustrates that the acoustic techniques, as described above, provides an accurate damage measurement. For example, acoustic technique based on tip damage mean error was 0.031%, thread damage mean error was 2.03%, and mass damage mean error was 0.008%. Simulation for the measured error is based on the auger with different combinations of δ for tip and thread damage, simulating resonance frequencies to estimate the changes in tip length, changes in damaged threads, and changed to mass of the rotating component.

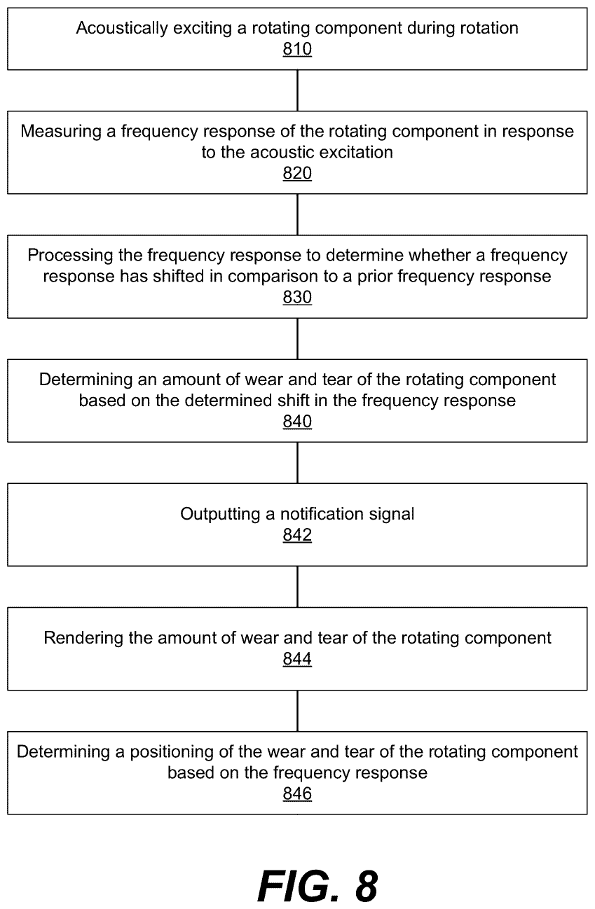

FIG. 8 shows a nonlimiting example of a flow diagram associated with determining damages to a rotating object in accordance with some embodiments. At step 810, a rotating component is acoustically excited during its rotation, as described above, e.g., using an acoustic transmitter. It is appreciated that acoustic excitation may have a range of frequencies associated therewith. At step 820, a frequency response of the rotating component is measured in response to the acoustic excitation, as described above, e.g., using a laser doppler vibrometer. At step 830, the frequency response is processed to determine whether a frequency response has shifted in comparison to a baseline frequency response, as described above, e.g., using a processor. In some embodiments, the baseline frequency response may be the frequency response of the same rotating component, e.g., right after installation, or it may be of a different but similar rotating component or it may be of a rotating component model. At step 840, the amount of wear and tear of the rotating component may be determined based on the determined shift in frequency response, as described above, e.g., using a processor. It is appreciated that determining the amount of wear and tear is independent of the value of the amplitude of the frequency response but is rather associated with frequencies associated with peaks of the frequency response. In some embodiments, the frequencies associated with peaks of the frequency response is compared to frequencies associated with peaks of the baseline frequency response to determine the amount of wear and tear of the rotating component. It is appreciated that the baseline frequency response may be from the same rotating component or a different rotating component that is substantially similar to the rotating component being excited (i.e., similar profile) or it may be from a model generated for the rotating component.

In some optional embodiments, at step 842, a notification signal may be an output to an operator that may be indicative of catastrophic damage to the rotating component and may be an output when the determined shift in frequency response exceeds a particular threshold. According to some embodiments, the notification may be displayed on a display, e.g., LCD. In some embodiments, the notification may be transmitted to a computing device, e.g., a smartphone, a computer, a tablet, etc., and may subsequently be rendered. In some optional embodiments, at step 844 the amount of determined wear and tear of the rotating component may be rendered on a display.

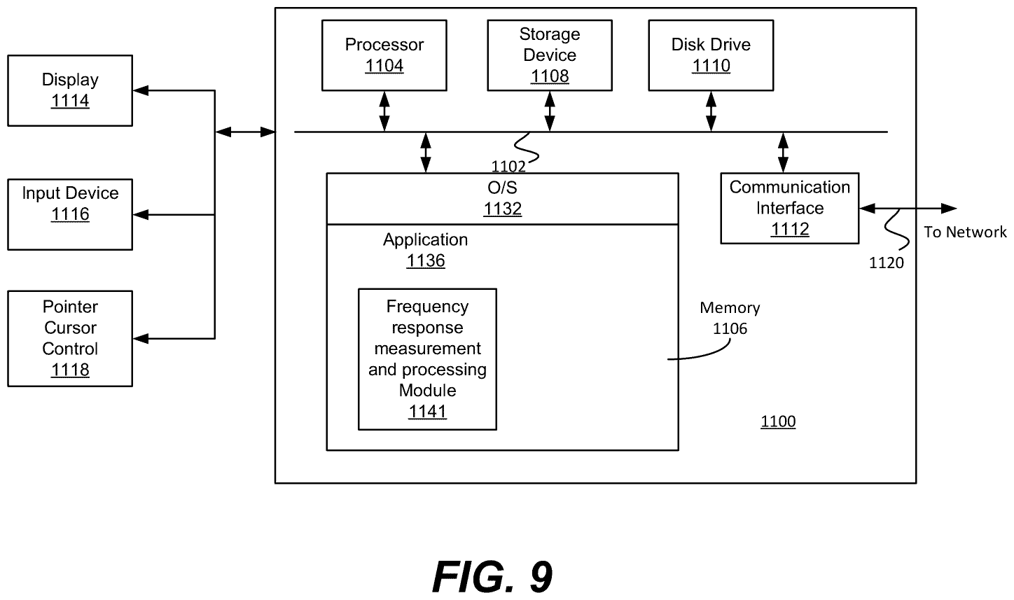

FIG. 9 shows a block diagram depicting an example of computer system suitable for measuring/processing frequency response of a rotating component in accordance with some embodiments. In some examples, computer system 1100 can be used to implement computer programs, applications, methods, processes, or other software to perform the above-described techniques and to realize the structures described herein. Computer system 1100 includes a bus 1102 or other communication mechanism for communicating information, which interconnects subsystems and devices, such as a processor 1104, a system memory (“memory”) 1106, a storage device 1108 (e.g., ROM), a disk drive 1110 (e.g., magnetic or optical), a communication interface 1112 (e.g., modem or Ethernet card), a display 1114 (e.g., CRT or LCD), an input device 1116 (e.g., keyboard), and a pointer cursor control 1118 (e.g., mouse or trackball). In one embodiment, pointer cursor control 1118 invokes one or more commands that, at least in part, modify the rules stored, for example in memory 1106, to define the electronic message preview process.

According to some examples, computer system 1100 performs specific operations in which processor 1104 executes one or more sequences of one or more instructions stored in system memory 1106. Such instructions can be read into system memory 1106 from another computer readable medium, such as static storage device 1108 or disk drive 1110. In some examples, hard-wired circuitry can be used in place of or in combination with software instructions for implementation. In the example shown, system memory 1106 includes modules of executable instructions for implementing an operating system (“OS”) 1132, an application 1136 (e.g., a host, server, web services-based, distributed (i.e., enterprise) application programming interface (“API”), program, procedure or others). Further, application 1136 includes a module of executable instructions associated with frequency response measurement and processing module 1141 to generate a frequency response of a rotating component when it is subjected to acoustic signals and to determine the amount of damage to the rotating component, as described above. The frequency response measurement and processing module 1141 further determines whether the rotating component should be repaired or replaced and in response thereto it may generate a signal to alert the operator, e.g., sending an email, turning on an LED, sending a Bluetooth signal, etc., as described above.

The term “computer readable medium” refers, at least in one embodiment, to any medium that participates in providing instructions to processor 1104 for execution. Such a medium can take many forms, including but not limited to, non-volatile media, volatile media, and transmission media. Non-volatile media includes, for example, optical or magnetic disks, such as disk drive 1110. Volatile media includes dynamic memory, such as system memory 1106. Transmission media includes coaxial cables, copper wire, and fiber optics, including wires that comprise bus 1102. Transmission media can also take the form of acoustic or light waves, such as those generated during radio wave and infrared data communications.

Common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, electromagnetic waveforms, or any other medium from which a computer can read.

In some examples, execution of the sequences of instructions can be performed by a single computer system 1100. According to some examples, two or more computer systems 1100 coupled by communication link 1120 (e.g., LAN, PSTN, or wireless network) can perform the sequence of instructions in coordination with one another. Computer system 1100 can transmit and receive messages, data, and instructions, including program code (i.e., application code) through communication link 1120 and communication interface 1112. Received program code can be executed by processor 1104 as it is received, and/or stored in disk drive 1110, or other non-volatile storage for later execution. In one embodiment, system 1100 is implemented as a hand-held device. But in other embodiments, system 1100 can be implemented as a personal computer (i.e., a desktop computer) or any other computing device. In at least one embodiment, any of the above-described delivery systems can be implemented as a single system 1100 or can implemented in a distributed architecture including multiple systems 1100.

In other examples, the systems, as described above can be implemented from a personal computer, a computing device, a mobile device, a mobile telephone, a facsimile device, a personal digital assistant (“PDA”) or other electronic device.

In at least some of the embodiments, the structures and/or functions of any of the above-described interfaces and panels can be implemented in software, hardware, firmware, circuitry, or a combination thereof. Note that the structures and constituent elements shown throughout, as well as their functionality, can be aggregated with one or more other structures or elements.

Alternatively, the elements and their functionality can be subdivided into constituent sub-elements, if any. As software, the above-described techniques can be implemented using various types of programming or formatting languages, frameworks, syntax, applications, protocols, objects, or techniques, including C, Objective C, C++, C#, Flex™, Fireworks®, Java™, Javascript™, AJAX, COBOL, Fortran, ADA, XML, HTML, DHTML, XHTML, HTTP, XMPP, Python, and others. These can be varied and are not limited to the examples or descriptions provided.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A method comprising:
acoustically exciting a rotating component;
measuring a signal response of the rotating component in response to the acoustic excitation;
processing the signal response to determine a difference in the signal response relative to a baseline signal response; and
determining an amount of wear and tear of the rotating component based on the difference in the signal response relative to the baseline signal response.

2. The method as described in claim 1, further comprising outputting a notification signal indicative of catastrophic damage to the rotating component in response to the determined shift in the signal response exceeding a threshold.

3. The method as described in claim 2, wherein the notification is rendered on a display.

4. The method as described in claim 1, wherein the acoustic excitation is for a range of frequencies.

5. The method as described in claim 1, wherein the determining the amount of wear and tear is based on determining peaks associated with the signal response.

6. The method as described in claim 1, wherein frequencies associated with peaks of the signal response is compared to frequencies associated with peaks of the baseline signal response to determine the amount of wear and tear of the rotating component.

7. The method as described in claim 6, wherein the baseline signal response is from the rotating component measured prior to any wear.

8. The method as described in claim 6, wherein the baseline frequency response is acquired from a numerical simulation of the rotating component.

9. The method as described in claim 6, wherein the baseline frequency response is from another rotating component.

10. The method as described in claim 1, further comprising determining a positioning of the wear and tear of the rotating component based on the signal response.

11. The method as described in claim 1, wherein the baseline signal response is from the rotating component after a certain period of time after wear and tear has occurred.

12. A system comprising:
an acoustic transmitter configured to generate an acoustic signal;
a component configured to rotate, wherein the acoustic signal acoustically excites the component during a rotating state or a stationary state;
a sensor configured to measure a signal response of the component in response to the acoustic excitation; and
a processor configured to process the signal response of the component, and wherein the processor is further configured to determine a difference in the signal response relative to a baseline signal response, and wherein the processor is further configured to determine an amount of wear and tear of the rotating component based on the difference in the signal response relative to the baseline signal response.

13. The system as described in claim 12, wherein the acoustic transmitter is a piezoelectric transducer.

14. The system as described in claim 12, wherein the component is an auger.

15. The system as described in claim 12, wherein the sensor is a laser Doppler vibrometer.

16. The system as described in claim 12, wherein the processor is further configured to output a notification signal indicative of catastrophic damage level to the component in response to the determined shift in the signal response exceeding a threshold.

17. The system as described in claim 16, further comprising a display where the notification signal is rendered.

18. The system as described in claim 16, further comprising a transmitter configured to transmit the notification to a computing device.

19. The system as described in claim 12, further comprising a display configured to render the amount of wear and tear of the rotating component.

20. The system as described in claim 12, wherein the processor is configured to determine the amount of wear and tear based on shift and distortion of resonance peaks associated with the signal response.

21. The system as described in claim 12, wherein the processor is configured to compare frequencies associated with peaks of the signal response to frequencies associated with peaks of the baseline signal response to determine the amount of wear and tear of the rotating component.
